(19) United States
(12) Patent Application Publication
(10) Pub. No.: US 2026/0062992 A1
(43) Pub. Date: Mar. 5, 2026

(54) Cordless Shade Apparatus with Adjustable Springs-Loaded Arrangement and Adjusting Method Thereof

(71) Applicant: Jiantian Ding, Walnut, CA (US)

(72) Inventor: Jiantian Ding, Walnut, CA (US)

(21) Appl. No.: 18/822,457

(22) Filed: Sep. 2, 2024

(51) Int. Cl. E06B 9/322

(52) U.S. Cl. CPC E06B 9/322; E06B 2009/3222

(57) ABSTRACT

A shade apparatus includes a slide seat slidably disposed in a slide channel of a headrail of the shade apparatus, wherein the slide seat includes two or more pairs of spring chambers which have different distances to a spring base mounted on one end portion of the slide channel of the headrail. Accordingly, a pair of coil springs is capable of selectively situating in one of the two or more pairs of the spring chambers while extension ends of the pair of the coil springs are connected to the spring base to adjust tensions of the pair of the coil springs for balancing a weight of a shade body and a bottom rail of the shade apparatus.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to shade apparatus, such as venetian blind, vertical blind, cellular blind, triple shade, roller shade, zebra shade, honeycomb shade, and curtain, and more particularly to a pull-down and push-up cordless shade apparatus equipped with adjustable springs-loaded arrangement which allows one or more pairs of coil springs to selectively provide various degrees of constant elastic force within an effective length of travel for shade apparatuses with different widths and lengths so as to balance the weight of the shade body and bottom rail thereof and to move the shade body smoothly and more lightly and stay level as the shade body is raised and lowered.

### Description of Related Arts

FIG. 1 illustrates a conventional cordless push-up and pull-down shade apparatus, which is a type of window covering system that allows the user to raise or lower a shade without the use of traditional cords or chains, comprising a shade body 10′, a bottom rail 20′ mounted on a bottom edge of the shade body 10′ and a headrail 30′ mounted on a top edge of the shade body 10′.

Instead of cords, these shades operate with an internal mechanism which is a spring-loaded mechanism that provides tension that holds the shade in place at the desired height. This system allows for smooth and easy adjustment. Without cords hanging down, the shade offers a cleaner and more streamlined appearance, which can be more aesthetically pleasing in modern interior designs.

An example of the spring-loaded mechanism is disclosed in U.S. Pat. No. 9,574,393 (hereinafter '393 patent), as shown in FIG. 2, which is embodied as a cord-winding device for a blind assembly having no pull cord, including a base seat A1 defining a slide channel A2 and having a bottom side A21 configured to removably mount the blind assembly thereto, and an adjustment unit A3 including a slide seat A31 mounted slidably in the slide channel A2, a plurality of rollers A4 mounted on the base seat A1 and the slide seat A31, respectively, and a constant force spring A51 of a spring unit A5 having first and second ends respectively fixed to the base seat A1 and the slide seat A31, which innovative configuration is that the first end of the constant force spring A51 is formed with a noncircular lock hole A511, the spring unit A5 further includes a pad A52 that has a protrusion inserted into the lock hole, and a fastener A53 to fix the first end of the constant force spring A51 to the base seat A1. In addition, a plurality of roller balls A6 is respectively received in the elongated recesses in the slide side walls of the slide body A31.

U.S. Pat. No. 11,193,327 (hereinafter '327 patent), as shown in FIG. 3A and FIG. 3B, discloses a spring winder B which improves the '393 patent and configures to have a pair of constant force springs B1, B2 configured to be extended along two opposing sides of the spring winder B, i.e. the slide seat of the '393 patent so as to provide more strengthened constant elastic force than the '393 patent. The claiming subject matter of the '327 patent is providing a guard plate B3 disposed vertically within the winder base B at one side of the extension end of the constant force spring B1, B2.

The pair of constant force springs B1, B2 of the '327 patent is horizontally accommodated in two through hole type springs slots B41, B42 between a top wall B51 and a bottom wall B52, wherein each spring slot B41, B42 has two opposing left and right openings B45 such that the extension end of one of the pair of constant force springs B1 can be extended out from the left opening B45 of one spring slot B41 along a left side of the spring winder B while the extension end of the another one of the pair constant force spring B2 can be extended out from the right opening B45 of another spring slot B42 along a right side of the spring winder B. Therefore, the distances between the pair of constant force springs B1, B2 and the fixed pully plug head, i.e. the base seat of the '393 patent, are different and thus the elastic forces of the pair of the constant force springs B1, B2 applied to the spring winder B with respect to the plug head are uneven that adversely affects smoothness of the push-up and pull down operation of the blinds.

In addition, each of the pair of constant force springs B1, B2 of the '327 patent, embodied as coil springs, is retained in the spring slots B41, B42 by means of bulge B31 of the guard plate B3 provided as a separation wall between the two spring slots B41, B42 in a horizontal manner, i.e. a center axis of the constant force spring B1, B2 is perpendicular to the top wall B51 and the bottom wall B52. However, such arrangement does not guarantee the prevention of the constant force spring B1, B2 from reeling off to the gaps between the spring winder B and the headrail of the blinds. When the constant force spring B1, B2 is being pulled to extend out by a sudden forceful pulling, the pulling force has a tendency of pulling the constant force spring B1, B2 towards the opening B45 of the spring slot B41, B42, causing off-centering movements of the two constant force springs B1, B2 to the right and to the left respectively in opposing directions that makes the pair of constant force springs B1, B2 more difficult to meet the symmetrical and average elastic force requirements thereof.

### SUMMARY OF THE PRESENT INVENTION

The invention is advantageous in that it provides an adjustable springs-loaded arrangement installed in a cordless shade apparatus, which is configured to allow one or more pairs of coil springs to selectively provide various degrees of constant tension force within an effective length of travel for the shade apparatuses with different widths and lengths for smooth and light operation.

Another advantage of the invention is to provide a cordless shade apparatus, wherein the constant tension force provided by the springs-loaded arrangement is adjustable to balance different weights of different shade apparatuses having different widths and lengths as they are raised by pushing up and lowered by pulling down.

Another advantage of the invention is to provide a cordless shade apparatus, wherein the extension ends of the one or more pairs of coil springs are arranged to be extended horizontally in an even and balance manner so as to ensure the one or more pairs of coil springs providing constant, symmetrical and even elastic force.

Another advantage of the invention is to provide a cordless shade apparatus, wherein each pair of the coil springs are arranged in a coaxially manner to ensure the extension ends of the pair of coil springs are being extended with equal lengths for providing even and balance elastic forces, so as to ensure the shade body to be pushed up and pulled down in a balance and smooth manner.

Another advantage of the invention is to provide a cordless shade apparatus, wherein each pair of the two or more pairs of the coil springs is situated vertically and coaxially in a slide seat of the springs-loaded arrangement and retained by two parallel side walls of the slide seat, such that the one or more pairs of the coil springs can be retained in position during the winding and unwinding of the extension ends of the pair of the coil springs taking advantageous of the gravity while the pair of the coil springs rolling along their axes in a coaxially, symmetrical and balance manner.

Another advantage of the invention is to provide a cordless shade apparatus, wherein the slide seat is configured to have two or more pairs of spring chambers each being defined by two parallel side walls and a bottom walls and having a top opening for fittingly situating a corresponding coil spring in the spring chamber, wherein the two side walls function as guiding surfaces for two sides of the corresponding coil spring situated in the spring chamber so as to ensure the winding and unwinding of the extension end of the coil spring, which is extending out through the bottom opening, in a steady and smooth manner.

Another advantage of the invention is to provide an adjusting method of the cordless shade apparatus, which allows the manufacturers to installed at least one pair of coil springs for a standard shade apparatus with standard width and length to shade a standard architecture opening such as a standard window sized 26″×64″, and to installed two or more pairs of the coil springs selectively for a shade apparatus with longer width and length to shade a bigger architecture opening such as a floor-to-ceiling window so as to ensure smooth and light push-up and pull-down operation.

Additional advantages and features of the invention will become apparent from the description which follows and may be realized by means of the instrumentalities and combinations particular point out in the appended claims.

According to the present invention, the foregoing and other objects and advantages are attained by a shade apparatus, comprising:
a shade body;
a bottom rail mounted on a bottom edge of the shade body;
a headrail, mounted on a top edge of the shade body, having two side wall and a bottom wall defining a slide channel longitudinal extended therein; and
a springs-loaded arrangement, housed in the headrail and configured to allow the bottom rail and the shade body to move up and down, comprising:
a slide seat, comprising at least two spring chamber seats integrally arranged parallelly and two sliding guider sets provided at left and right sides thereof symmetrically, wherein each of the two spring chamber seats has two or more spring chambers, such that the spring chambers of the two spring chamber seats are aligned symmetrically and parallelly to form two or more pairs of the spring chambers, wherein each of the two or more pairs of the spring chambers has a bottom opening which is closed by the bottom wall of the headrail when the slide seat is slidably disposed in the slide channel of the headrail with the bottom openings facing downwards,
a spring base, mounted on one end portion of the slide channel in the headrail, having a pair of spring grooves parallelly provided in a bottom side thereof and facing the bottom wall of the headrail,
a pair of guiding rails respectively protruded inwardly and extended longitudinal along the side walls of the headrail symmetrically, the pair of guiding rails slidably engaging with the two sliding guider set of the slide seat situated in the slide channel so as to allow and guide the slide seat to be sliding along the slide channel, and
one or more pairs of coil springs, wherein each pair of the one or more pairs of the coil springs are situated in the corresponding pair of the spring chambers and extension ends of the each pair of the one or more pairs of the coil springs are extended to the pair of spring grooves and secured to the spring base respectively, such that when the bottom rail is pushed upwards the one or more pairs of the coil springs are tightened, the shade body and the bottom rail move towards the headrail, wherein when the bottom rail stops being pushed up, the springs-load arrangement automatically locks, holding the shade body and the bottom rail in a new, raised position thereof, wherein when the bottom rail is pulled down, the shade body is lowered as the bottom rail moves downward to release tensions in the one or more pairs of the coil springs, wherein the one or more pairs of the coil springs allow the shade body and the bottom rail to lower, while ensuring a release of tension of each of the one or more pair of the coil springs is gradually, allowing for a smooth and light lowering of the shade body and the bottom rail, wherein when the bottom rail stops being pulled down, the springs-loaded arrangement again locks into place, securing the shade body and the bottom rail at a desired height.

When the shade apparatus is a blind apparatus, such as venetian blind, vertical blind, cellular blind, triple shade, roller shade, zebra shade, honeycomb shade, curtain and the like, the springs-loaded arrangement of the shade apparatus further comprises a roller unit mounted to one end of the slide seat facing the roller seat and the shade apparatus further comprises a shade body up and down operating seat, such as a roller seat, mounted on one end portion of the slide channel in the headrail, and a hidden lift cord assembly having one or more internal lift cords that run vertically through the shade body and attached to the bottom rail and threaded horizontally through the roller unit and the roller seat inside the headrail, such that when the bottom rail is pushed upwards, the one or more lift cords move upward as well causing the shade body to gather and move toward the headrail, wherein as the one or more pairs of the coil springs tighten, the one or more internal lift cords are pulled and in turn to pull the shade body and the bottom rail upward, wherein when the bottom rail stops being pushed up, the springs-load arrangement automatically locks, holding the one or more internal lift cords in a new, raised position thereof, and that when the bottom rail is pulled down, the shade body is lowered and spread out evenly as the bottom rail moves downward to release tensions in the one or more pairs of the coil springs, wherein the one or more pairs of the coil springs allow the one or more internal lift cords to extend, lowering the shade body and the bottom rail, while ensuring a release of tension of each of the one or more pair of the coil springs is gradually, allowing for a smooth and light lowering of the shade body and the bottom rail, wherein when the bottom rail stops being pulled down, the springs-loaded arrangement again locks into place, securing the one or more internal lift cords and keep the shade body and the bottom rail at a desired height.

In one embodiment, a first pair of coil springs is preferred to be situated in the first pair of spring chambers closest to the spring base. When a second pair of coil springs is embodied, the second pair of coil springs is situated in the second pair of spring chambers adjacent to the first pair of spring chambers. When a third pair of coil springs is embodied, the third pair of coil springs is situated in the third pair of spring chambers adjacent to the second pair of spring chambers. Similarly, when a fourth pair of coil springs is embodied, the fourth pair of coil springs is situated in the fourth pair of spring chambers adjacent to the third pair of spring chambers. In addition, each of the first pair, second pair, third pair, and fourth pair of the spring chambers is arranged in a parallel and symmetric manner to allow the corresponding pair of the coil springs to be rolling therein as coaxially and symmetrically as possible.

In one embodiment, each of the two spring chamber seats has a receiving slot and one or more chamber walls dividing the receiving slot into the two or more spring chambers.

In one embodiment, each of the one or more spring chambers is defined by two chamber side walls, a chamber top wall to define the bottom opening, such that the corresponding coil spring is fittingly situated between the two chamber side walls while the bottom opening allows the extension end of the coil spring to extend along an extension gap formed between a bottom surface of the slide seat and the bottom wall of the headrail and to securely connect to the spring base, wherein the chamber top wall substantially retains the coil spring in the spring chamber and prevents the spring chamber from moving upwards. Therefore, the coil spring is retained by the chamber side walls, the chamber top wall and the bottom wall of the headrail in position.

In one embodiment, each of the sliding guider set is preferred to include two sliding guiders each has a guiding slot configured to allow the corresponding guiding rails to slidably insert therealong.

In accordance with another aspect of the invention, the present invention further provides an adjusting method of a shade apparatus, comprising steps of:
providing a slide seat slidably in a slide channel of a headrail of the shade apparatus, wherein the slide seat having two or more pairs of spring chambers, wherein each of the two or more pairs of the spring chambers has a bottom opening which is closed by a bottom wall of the headrail when the slide seat is slidably disposed in the slide channel of the headrail with the bottom openings facing downwards; and
situating a first pair of coil springs in a first pair of the two or more pairs of the spring chambers which is closest to a spring base and connecting extension ends of the first pair of the coil springs to a spring base mounted on one end portion of the slide channel of the headrail.

In one embodiment, the adjusting method further comprises steps of:
situating a second pair of coil springs to another pair of the two or more pairs of the spring chambers of the slide seat; and
connecting extension ends of the second pair of the coil springs to the spring base.

In one embodiment, the second pair of the coil springs is situated in a second pair of the two or more pairs of the spring chambers adjacent to the first pair of the spring chambers.

In one embodiment, the adjusting method further comprises steps of:
situating a third pair of coil springs to a third pair of the two or more pairs of the spring chambers of the slide seat; and
connecting extension ends of the third pair of the coil springs to the spring base.

In one embodiment, the adjusting method further comprises steps of:
situating a fourth pair of coil springs to a fourth pair of the two or more pairs of the spring chambers of the slide seat; and
connecting extension ends of the fourth pair of the coil springs to the spring base.

In accordance with another aspect of the invention, the present invention further provides an adjusting method of a shade apparatus, comprising steps of:
providing a slide seat slidably in a slide channel of a headrail of the shade apparatus, wherein the slide seat comprising two or more pairs of spring chambers, wherein each of the two or more pairs of the spring chambers has a bottom opening which is closed by a bottom wall of the headrail when the slide seat is slidably disposed in the slide channel of the headrail with the bottom openings facing downwards, wherein the two or more pairs of the spring chambers have different distances to a spring base mounted on one end portion of the slide channel of the headrail; and
selectively situating a pair of coil springs in one of the two or more pairs of the spring chambers and connecting extension ends of the pair of the coil springs to the spring base to adjust tensions of the pair of the coil springs for balancing a weight of a shade body and a bottom rail of the shade apparatus.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a conventional cordless push-up and pull-down shade apparatus.

FIG. 2 is a partial exposed perspective view illustrating a conventional spring-loaded mechanism as disclosed in U.S. Pat. No. 9,574,393.

FIG. 3A is a perspective view illustrating a conventional spring winder as disclosed in U.S. Pat. No. 11,193,327.

FIG. 3B is a sectional plan view illustrating the conventional spring winder as shown in FIG. 3A.

FIG. 4 is a partial perspective view of a shade apparatus with adjustable springs-loaded arrangement according to a preferred embodiment of the present invention.

FIG. 5 is a plan view of the shade apparatus with adjustable springs-loaded arrangement according to the above preferred embodiment of the present invention.

FIG. 6 is a side perspective view of the shade apparatus with adjustable springs-loaded arrangement according to the above preferred embodiment of the present invention.

FIG. 7 is an exploded view illustrating the springs-loaded arrangement and the headrail of the shade apparatus with adjustable springs-loaded arrangement according to the above preferred embodiment of the present invention.

FIG. 8 is a bottom perspective view illustrating the slide seat, the spring base and a pair of coil springs as example of the adjustable springs-loaded arrangement of the shade apparatus according to the above preferred embodiment of the present invention.

FIG. 8 is an exploded bottom perspective view illustrating the slide seat, the spring base and one pair of coil springs situated in the first pair of spring chambers of the adjustable springs-loaded arrangement of the shade apparatus according to the above preferred embodiment of the present invention.

FIG. 10A to FIG. 10C are sectional views illustrating the pair of coil springs situated in different pair of spring chambers in the slide seat with respect to the spring base of the adjustable springs-loaded arrangement of the shade apparatus according to the above preferred embodiment of the present invention.

FIG. 11 is a partial sectional view illustrating multiple pairs of coil springs situated in corresponding pairs of the spring chambers in the slide seat with respect to the spring base of the adjustable springs-loaded arrangement of the shade apparatus according to the above preferred embodiment of the present invention.

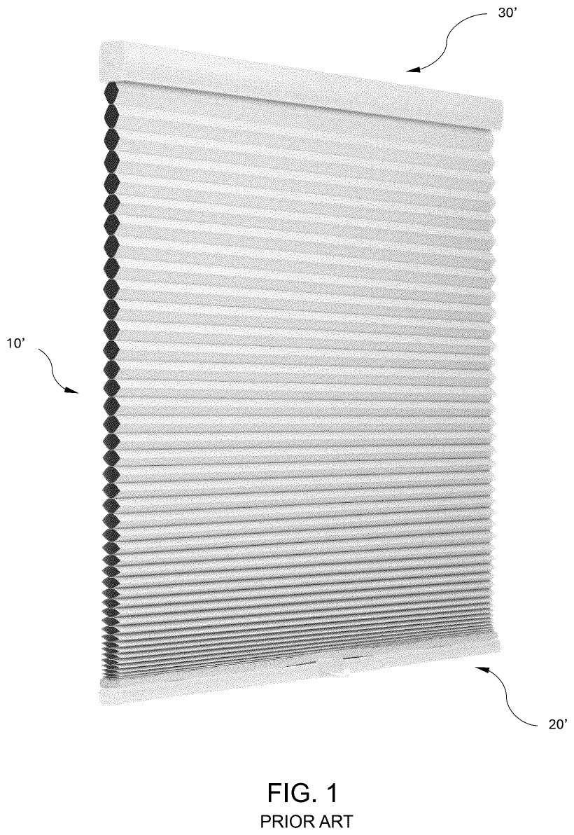

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art. Also, when the first feature is described as being “above” or “below” the second feature, this may entail direct physical contact between the two features. Alternatively, it may signify that the first and second features are not in direct contact but are linked through the involvement of additional features. Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In this embodiment's description, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

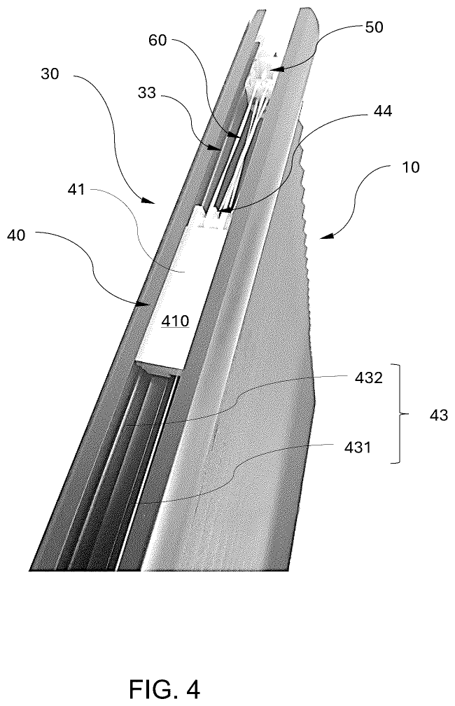

Referring to FIG. 4 to FIG. 6, a shade apparatus with adjustable springs-loaded arrangement according to a preferred embodiment of the present invention is illustrated. The shade apparatus comprises a shade body 10, a bottom rail 20, a headrail 30, and a springs-loaded arrangement 40.

The bottom rail 20 mounted on a bottom edge of the shade body 10. The headrail 30 is mounted on a top edge of the shade body 10, having two side wall 31 and a bottom wall 32 defining a slide channel 33 longitudinal extended therein. The roller seat 40 is mounted on one end portion of the slide channel 33 in the headrail 30.

The springs-loaded arrangement 40, which is housed in the headrail 30 and configured to allow the bottom rail 20 and the shade body 10 to move up and down, comprises a slide seat 41, a spring base 42, one or more pairs of coil springs 43, and a pair of guiding rails 45.

Each of the one or more pairs of the coil springs 43 of the springs-loaded arrangement 40 is embodied to have a left coil spring 431, and a right coil springs 432 which are the critical components that symmetrically balances a weight of the shade body 10 and the bottom rail 20, allowing them to stay in place at any desired position without the need for external cords, wherein when the shade body 10 is pulled down, the at least one pair of the coil springs wind up, increasing tension. This tension provides an upward force that counteracts the downward force of gravity acting on the shade body 10 and the bottom rail 20.

According to the preferred embodiment of the present invention, the shade apparatus is embodied as a blind assembly, such as venetian blinds, cellular blinds and the like, which further comprises a roller seat 50 and a hidden lift cord assembly 60, and the springs-loaded arrangement 40 further comprises a roller unit 44.

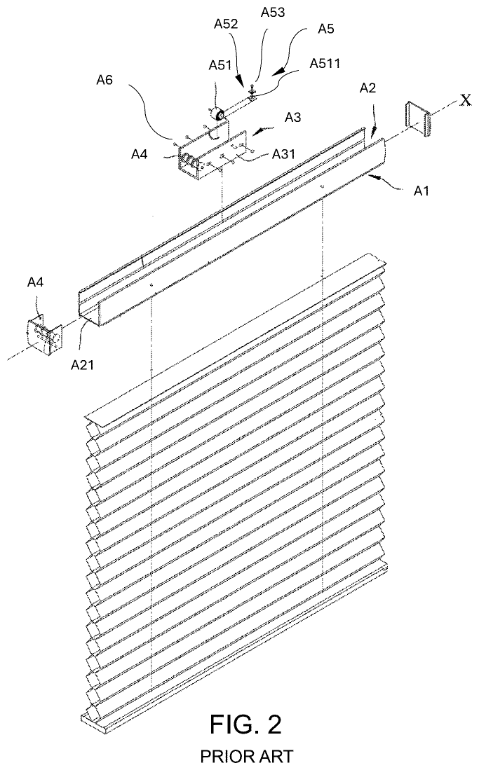

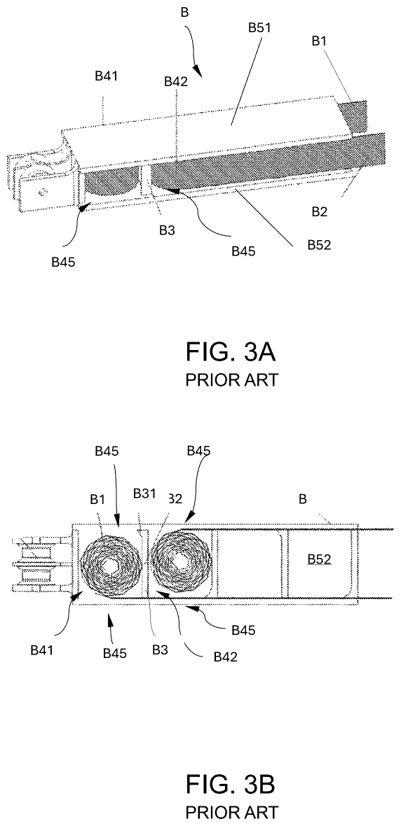

The pair of the left and right coil springs 431, 432 is designed to be in a state of equilibrium when the shade body 10 is partially extended. In comparison with the single coil spring arrangement as shown in FIG. 2, the pair of the left and right coil springs 431, 432 of the present invention are arranged in a pairing manner to wind and unwind coaxially and symmetrically to provide strengthened and more balance tension through the pair of the left and right coil springs 431, 432 to precisely match the weight of the shade body 10 and the bottom rail 20. In addition, the unbalancing drawback of the two horizontally arranged coil springs of the conventional blinds as shown in FIG. 3A and FIG. 3B is improved by the symmetrical arrangement of the one or more pairs of the left and right coil springs 431, 432 of the present invention.

Accordingly, when the shade body 10 and the bottom rail 20 is pulled further down, a combined tension of the at least one pair of the left and right coil springs 431, 432 is increased in a more balance manner, which will balance the additional length of the shade body 10. Similarly, if the shade body 10 is pushed up, the combined tension in the at least one pair of the left and right coil springs 431, 432 decreases, but it still balances the weight of the remaining extended portion of the shade body. It is appreciated that each of the coil springs 431, 432 is designed with a variable tension mechanism. This means that the tension increases more rapidly as the shade body 10 is extended, ensuring that the coil spring 431, 432 can effectively balance the weight of the shade body throughout its entire range of motion while assisting the at least one pair of the left and right coil springs 431, 432 in holding the shade body 10 and the bottom rail 20 at the desired height so as to prevent the shade body 10 from moving unintentionally.

Conventionally, in the design and manufacture of the shade apparatus, the balance can only be achieved through careful calibration of the coil spring to match the weight of the shade apparatus, often supplemented by friction or damping mechanisms to ensure stability. In other words, different shade apparatuses with different widths and lengths should incorporate with different coil springs with different tensions. This requires the manufacturers to design and warehousing multiple types of coil springs with different tensions, number of coils and etc.. It not only increases the cost of the shade apparatus but also complicates the manufacturing process and quality control for ensuring installing the proper coil springs to different models of shade apparatus.

For example, to determine which type of coil spring is needed to balance the weight of a particular shade apparatus involves a few key steps. The primary factors include the weight of the shade body and the bottom rail, the spring constant k (stiffness, measured in Newtons per meter N/m, or pounds per inches) of the coil spring, and the mechanical design of the spring system.

Generally, the calibration formula is that the force required to balance the shade body and bottom rail is equal to the weight of the blinds multiplied by the acceleration due to gravity (g=9.81 m/s² or 32.2 ft/s² in imperial units).

$${F}_{balance} = Weight \times g$$

The present invention is aimed to solve the above conventional drawbacks by equipping the shade apparatus with the same springs-loaded arrangement 60 with one type of coil spring for various shade apparatus with different configurations, widths and lengths.

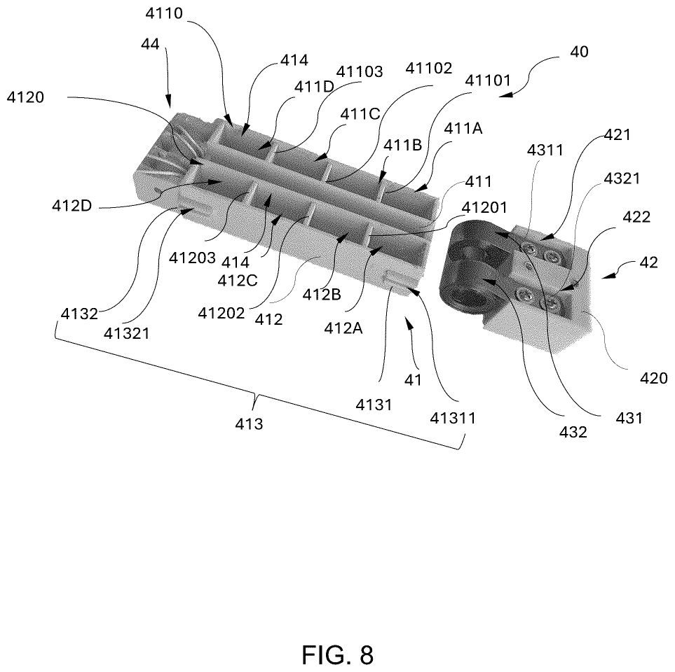

Further referring to FIG. 7 to FIG. 11, the springs-loaded arrangement 40 (as well as the headrail 30 in FIG. 7) is illustrated in an upside down manner, e.g. its bottom side 410 facing upwards, for illustration purposes. The slide seat 41 comprises at least two spring chamber seats, i.e. a first spring chamber seat 411 and a second chamber seat 412, integrally arranged parallelly and two sliding guider sets 413 provided at left and right sides thereof symmetrically and respectively, wherein each of the two spring chamber seats 411, 412 has two or more spring chambers 411A, 411B, 411C, 411D, 412A, 412B, 412C, 412D, such that the spring chambers 411A-411D, 412A-412D of the two spring chamber seats 411, 412 are aligned symmetrically and parallelly to form two or more pairs of the spring chambers 411A-411D, 412A-412D. According to the preferred embodiment of the present invention, the two parallel spring chambers 411A, 412A form a first pair of the spring chambers 411A, 412A arranged closest to the spring base 42. Another two parallel spring chambers 411B, 412B form a second pair of the spring chambers 411B, 412B aligned adjacent to the first pair of the spring chambers 411A, 412A. Another two parallel spring chambers 411C, 412C form a third pair of the spring chambers 411C, 412C aligned adjacent to the second pair of the spring chambers 411B, 412B. Another two parallel spring chambers 411D, 412D form a fourth pair of the spring chambers 411D, 412D aligned adjacent to the third pair of the spring chambers 411C, 412C.

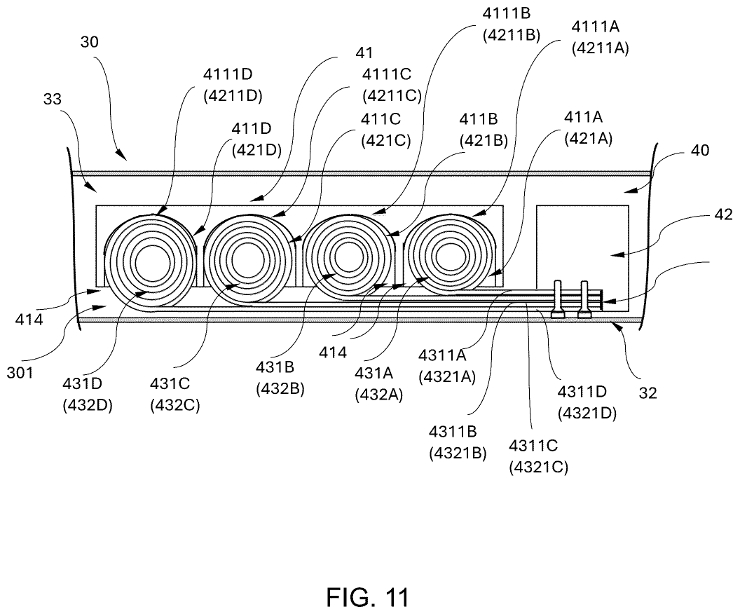

As shown in FIG. 11, each of the two or more pairs of the spring chambers 411A, 412A, 411B, 412B, 411C, 412C, 411D, 412D has a bottom opening 414, sized and shaped to allow the corresponding coil spring 431, 432 to be disposed in the spring chambers 411A, 412A, 411B, 412B, 411C, 412C, 411D, 412D therethrough, and a curved top surface 4111A, 4121A, 4111B, 4121B, 4111C, 4121C, 4111D, 4121D, sized and shaped to fit a curvature of corresponding coil spring 431, 432 to fittingly support the corresponding coil spring 431, 432 being situated thereon, wherein the bottom openings 414 are is closed by the bottom wall 32 of the headrail 30 when the slide seat 41 is slidably disposed in the slide channel 33 of the headrail 30 with the bottom openings 414 facing downwards.

According to the preferred embodiment of the present invention, referring to FIG. 9, each of the two spring chamber seats 411, 412 has a receiving slot 4110, 4120 and three chamber walls 41101, 41102, 41103, 41201, 41202, 41203 dividing the receiving slot 4110, 4120 into the two or more spring chambers 411A, 412A, 411B, 412B, 411C, 412C, 411D, 412D. Each of the spring chambers 411A, 412A, 411B, 412B, 411C, 412C, 411D, 412D is preferred to have the same length, width and depth for receiving the corresponding coil spring 431, 432.

In particular, each of the one or more spring chambers 411A, 412A, 411B, 412B, 411C, 412C, 411D, 412D is defined by two chamber side walls, a chamber top wall to define the bottom opening 414, such that the corresponding coil spring 431, 432 is fittingly situated between the two chamber side walls while the bottom opening 414 allows the extension end 4311, 4321 of the coil spring 431, 432 to extend along an extension gap 301 (as shown in FIG. 7 and FIG. 11) formed between a bottom surface of the slide seat 30 and the bottom wall 32 of the headrail 30 and to securely connect to the spring base, wherein the chamber top wall substantially retains the coil spring in the spring chamber and prevents the spring chamber from moving upwards. Therefore, the coil spring is retained by the chamber side walls, the chamber top wall and the bottom wall of the headrail in position.

The spring base 42 is mounted on another end portion of the headrail 30 within the slide channel 33, having a pair of spring grooves 421, 422 parallelly provided in a bottom side 420 thereof and facing the bottom wall 32 of the headrail 30.

Each pair of the one or more pairs of coil springs 431, 432 is situated in the corresponding pair of the spring chambers 411A, 412A, 411B, 412B, 411C, 412C, 411D, 412D and extension ends 4311, 4321 of the each pair of the one or more pairs of the coil springs 431, 432 are extended to the pair of spring grooves 421, 422 and securely connected to the spring base 42 respectively, for example by screwing.

As shown in FIG. 7 to FIG. 9, one pair of coil springs 431, 432 is illustrated as an illustration example. It is understood that, according to the preferred embodiment of the present invention, four pairs of the spring chambers 411A, 412A, 411B, 412B, 411C, 412C, 411D, 412D are provided in the slide seat 41, and thus four pairs of the coil springs 431A, 432A, 431B, 432B, 431C, 432C, 431D, 432D can be embodied to situated in the four pairs of the coil chambers 411A, 412A, 411B, 412B, 411C, 412C, 411D, 412D respectively as illustrated in FIG. 11.

As mentioned above, when the shade apparatus is a venetian blinds, cellular blinds or the like, the shade apparatus further comprises the roller unit 44 mounted to one end of the slide seat 41 facing the roller seat 50.

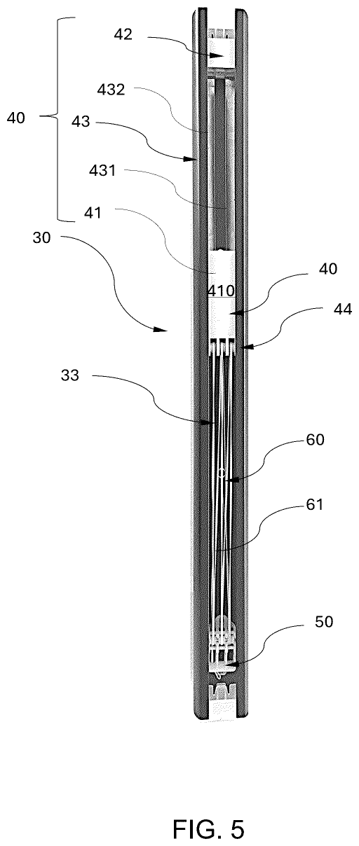

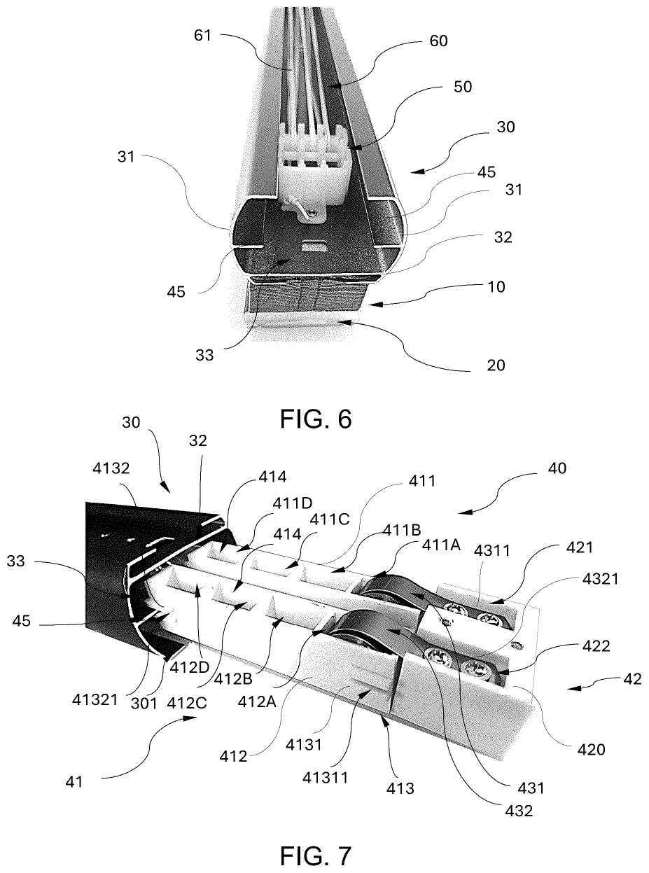

Referring to FIG. 5, FIG. 6 and FIG. 7, the pair of guiding rails 45 respectively protruded inwardly and extended longitudinal along the side walls 31 of the headrail 30 symmetrically, wherein the pair of guiding rails 45 slidably engaging with the two sliding guider set 413 of the slide seat 41 situated in the slide channel 33 so as to allow and guide the slide seat 30 to be sliding along the slide channel 33 between the spring base 42 and the roller seat 50.

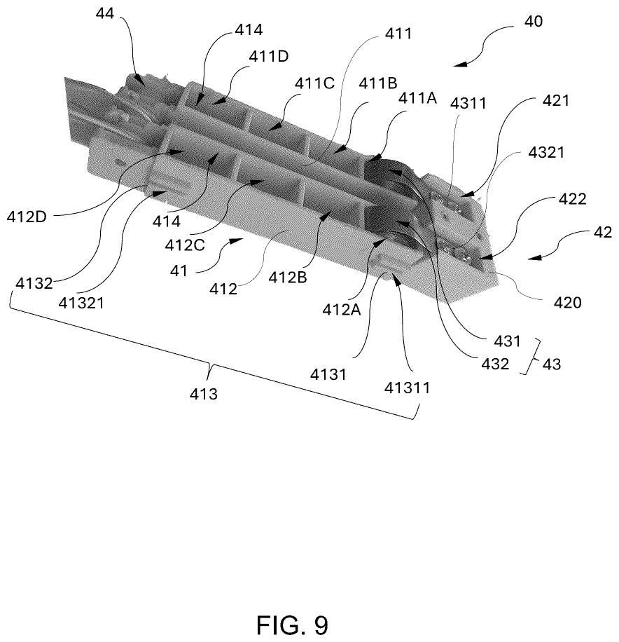

As shown in FIG. 8, the springs-loaded arrangement 40 of the shade apparatus of the present invention is illustrated, each of the sliding guider set 413 is preferred to include two sliding guiders 4131, 4132 each has a guiding slot 41311, 41321 configured to allow the corresponding guiding rails 45 to slidably insert therealong, such that the slide seat 41 is able to smoothly slide along the slide channel 33 between the spring base 42 and the roller seat 50 during the balancing of the tension of the one or more pairs of the coil springs 431, 432 and the weight of the shade body 10 and the bottom rail 20.

Referring to FIG. 5 and FIG. 6, the hidden lift cord assembly 60 having one or more internal lift cords 61 that run vertically through the shade body 10 and attached to the bottom rail 20 and threaded horizontally through the roller unit 50 and the roller seat 44 inside the headrail 30, such that when the bottom rail 20 is pushed upwards, the one or more lift cords 61 move upward as well causing the shade body 10 to gather and move toward the headrail 30, wherein as the one or more pairs of the coil springs 431, 432 tighten, the one or more internal lift cords 61 are pulled and in turn to pull the shade body 10 and the bottom rail 20 upward. When the bottom rail 20 stops being pushed up, the springs-load arrangement 40 automatically locks, holding the one or more internal lift cords 61 in a new, raised position thereof, and that when the bottom rail 20 is pulled down, the shade body 10 is lowered and spread out evenly as the bottom rail 20 moves downward to release tensions in the one or more pairs of the coil springs 431, 432, wherein the one or more pairs of the coil springs 431, 432 allow the one or more internal lift cords 61 to extend, lowering the shade body 10 and the bottom rail 20, while ensuring a release of tension of each of the one or more pair of the coil springs 431, 432 is gradually, allowing for a smooth and light lowering of the shade body 10 and the bottom rail 20. When the bottom rail 20 stops being pulled down, the springs-loaded arrangement 40 again locks into place, securing the one or more internal lift cords 61 and keep the shade body 10 and the bottom rail 20 at a desired height.

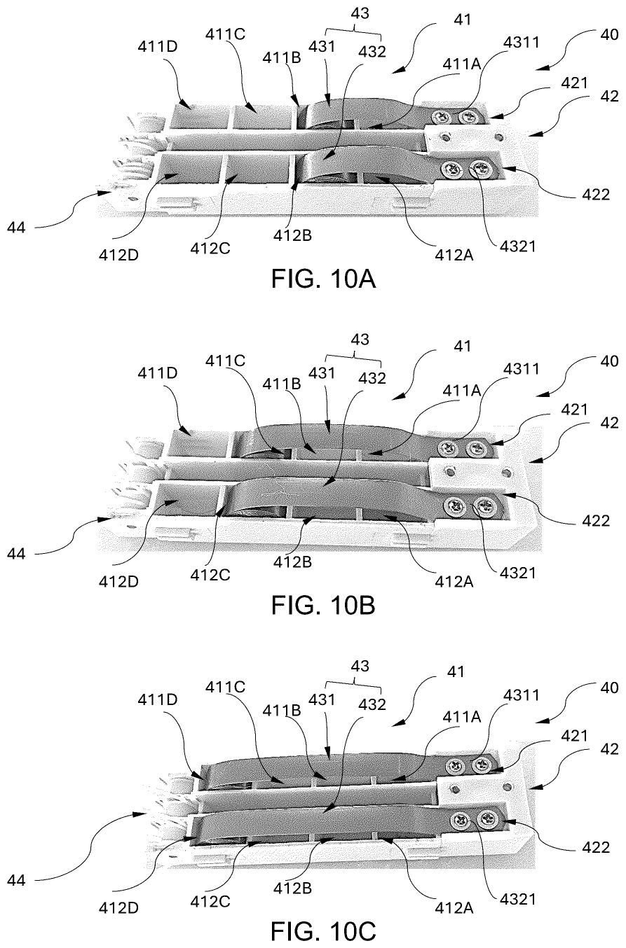

Referring to FIG. 9 and FIGS. 10A-10C, the manufacturer of the shade apparatus of the present invention is capable of adjusting the constant tension of the pair of the coil springs 431, 432 according to the weight of the shade body 10 and the bottom rail 20 by selecting the one of the four pairs of the spring chambers (411A, 412A), (411B, 412B), (411C, 412C), (411D, 412D) to situate in position.

For the same pair of the coil springs 431, 432 with the same spring constant, highest constant tension is provided by the pair of the coil springs 431, 432 when the pair of the coil springs 431, 432 is situated in the first pair of the spring chambers 411A, 421A as shown in FIG. 9. Higher constant tension is provided by the pair of the coil spring 431, 432 when the pair of the coil springs 431, 432 is situated in the second pair of the spring chambers 411B, 421B as shown in FIG. 10A. Lower constant tension is provided by the pair of the coil springs 431, 432 when the pair of the coil springs 431, 432 is situated in the third pair of the spring chambers 411C, 421C as shown in FIG. 10B. Lowest constant tension is provided by the pair of the coil springs 431, 432 when the pair of the coil springs 431, 432 is situated in the fourth pair of the spring chambers 411C, 421D as shown in FIG. 10c.

Accordingly, the present invention provides an adjusting method of the shade apparatus with the adjustable springs-loaded arrangement 40, which includes steps of:
providing the slide seat 41 slidably in the slide channel 33 of a headrail 30 of the shade apparatus, wherein the slide seat 41 having two or more pairs of spring chambers (411A, 412A), (411B, 412B), (411C, 412C), (411D, 412D), wherein the bottom opening 414 of each of the two or more pairs of the spring chambers (411A, 412A), (411B, 412B), (411C, 412C), (411D, 412D) is closed by the bottom wall 32 of the headrail 30 when the slide seat 41 is slidably disposed in the slide channel 33 of the headrail 30 with the bottom openings 414 facing downwards, wherein the two or more pairs of the spring chambers (411A, 412A), (411B, 412B), (411C, 412C), (411D, 412D) have different distances to the spring base 42 mounted the one end portion of the slide channel 33 of the headrail 30; and
selectively situating one pair of the coil springs 431, 432 in one of the two or more pairs of the spring chambers (411A, 412A), (411B, 412B), (411C, 412C), (411D, 412D) and connecting extension ends 4311, 4321 of the pair of the coil springs 431, 432 to the spring base 42 to adjust tensions of the pair of the coil springs 431, 432 for balancing the weight of the shade body 10 and the bottom rail 20 of the shade apparatus.

Referring to FIG. 11, in accordance with another aspect of the invention, the present invention further provides an alternative adjusting method of the shade apparatus with adjustable springs-loaded arrangement 40, including steps of:
providing the slide seat 41 slidably in the slide channel 33 of the headrail 30 of the shade apparatus, wherein the slide seat 41 having two or more pairs of spring chambers (411A, 412A), (411B, 412B), (411C, 412C), (411D, 412D), wherein each of the two or more pairs of the spring chambers (411A, 412A), (411B, 412B), (411C, 412C), (411D, 412D) has the bottom opening 414 which is closed by the bottom wall 32 of the headrail 30 when the slide seat 41 is slidably disposed in the slide channel 33 of the headrail 30 with the bottom openings 414 facing downwards; and
situating a first pair of coil springs 431A, 432A in a first pair of the two or more pairs of the spring chambers 411A, 421A which is closest to the spring base 42 and connecting the extension ends 4111A, 4211A of the first pair of the coil springs 431A, 432A to the spring base 42 mounted on the one end portion of the slide channel 33 of the headrail 30.

According to the preferred embodiment, the adjusting method further includes steps of:
situating a second pair of coil springs 431B, 432B to another pair of the two or more pairs of the spring chambers (411B, 421B), (411C, 421C), (411D, 421D) of the slide seat 41; and
connecting the extension ends 4311B, 4321B of the second pair of the coil springs 431B, 432B to the spring base 42.

According to the preferred embodiment, the second pair of coil springs 431B, 432B is situated in the second pair of the two or more pairs of the spring chambers 411B, 421B adjacent to the first pair of the spring chambers 411A, 421A.

According to the preferred embodiment, the adjusting method further includes steps of:
situating a third pair of the coil springs 431C, 432C to a third pair of the two or more pairs of the spring chambers 411C, 421C of the slide seat 41; and
connecting the extension ends 4311C, 4321C of the third pair of the coil springs 431C, 432C to the spring base 42.

According to the preferred embodiment, the adjusting method further includes steps of:
situating a fourth pair of the coil springs 431D, 432D to a fourth pair of the two or more pairs of the spring chambers 411D, 421D of the slide seat 41; and
connecting the extension ends 4311D, 4321D of the fourth pair of the coil springs 431D, 432D to the spring base 42.

In view of above, the shade apparatus equipped with the adjustable springs-loaded arrangement 41 is configured to allow one or more pairs of coil springs to selectively provide various degrees of constant tension force within an effective length of travel for shade apparatuses with different widths and lengths for smooth and light operation. In other words, the constant tension force provided by the springs-loaded arrangement 40 is adjustable to balance different weights of different shade apparatuses having different widths and lengths as they are raised by pushing up and lowered by pulling down.

Since the extension ends 4311, 4321 of the one or more pairs of the coil springs 431, 432 are arranged to be extended horizontally in an even and balance manner so that the one or more pairs of the coil springs 431, 432 is ensured to provide constant, symmetrical and even elastic force. In addition, each pair of the coil springs 431, 432 are arranged in a coaxially manner to ensure the extension ends 4311, 4321 of the pair of the coil springs 431, 432 being extended with equal lengths for providing even and balance elastic forces, so as to ensure the shade body 10 to be pushed up and pulled down in a balance and smooth manner.

It is appreciated that each pair of the two or more pairs of the coil springs 431, 432 is situated vertically and coaxially in a slide seat 41 of the springs-loaded arrangement 40 and retained by two parallel side walls of the slide seat 41, such that the one or more pairs of the coil springs 431, 432 can be retained in position during the winding and unwinding of the extension ends 4311, 4321 of the pair of the coil springs 431, 432 while the pair of the coil springs 431, 432 rolling along their axes in a coaxially, symmetrical and balance manner. It is worth mentioning that the two side walls of each of the spring chambers 411A, 412A, 411B, 412B, 411C, 412C, 411D, 412D function as guiding surfaces for two sides of the corresponding coil spring 431, 432 situated in the spring chamber 411A, 412A, 411B, 412B, 411C, 412C, 411D, 412D so as to ensure the winding and unwinding of the extension end 4311, 4321 of the coil spring 431, 432, which is extending out through the bottom opening 414, in a steady and smooth manner.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A shade apparatus, comprising:
a shade body;
a bottom rail mounted on a bottom edge of said shade body;
a headrail, mounted on a top edge of said shade body, having two side wall and a bottom wall defining a slide channel longitudinal extended therein; and
a springs-loaded arrangement, housed in said headrail and configured to allow said bottom rail and said shade body to move up and down, comprising:
a slide seat, comprising at least two spring chamber seats integrally arranged parallelly and two sliding guider sets provided at left and right sides thereof symmetrically, wherein each of said two spring chamber seats has two or more spring chambers, such that said spring chambers of said two spring chamber seats are aligned symmetrically and parallelly to form two or more pairs of said spring chambers, wherein each of said two or more pairs of said spring chambers a bottom opening which is closed by said bottom wall of said headrail when said slide seat is slidably disposed in said slide channel of said headrail with said bottom openings facing downwards,
a spring base, mounted on one end portion of said slide channel in said headrail, having a pair of spring grooves parallelly provided in a bottom side thereof and facing said bottom wall of said headrail,
a pair of guiding rails respectively protruded inwardly and extended longitudinal along said side walls of said headrail symmetrically, said pair of guiding rails slidably engaging with said two sliding guider set of said slide seat situated in said slide channel so as to allow and guide said slide seat to be sliding along said slide channel, and
one or more pairs of coil springs, wherein one pair of said one or more pairs of said coil springs are situated one pair of said two or more pairs of said spring chambers and extension ends of said one pair of said one or more pairs of said coil springs are extended and secured to said spring base, such that when said bottom rail is pushed upwards said one or more pairs of said coil springs are tightened, said shade body and said bottom rail move towards said headrail, wherein when said bottom rail stops being pushed up, said springs-load arrangement automatically locks, holding said shade body and said bottom rail in a new, raised position thereof, wherein when said bottom rail is pulled down, said shade body is lowered as said bottom rail moves downward to release tensions in said one or more pairs of said coil springs, wherein said one or more pairs of said coil springs allow said shade body and said bottom rail to lower, while ensuring a release of tension of each of said one or more pair of said coil springs is gradually, allowing for a smooth lowering of said shade body and said bottom rail, wherein when said bottom rail stops being pulled down, said springs-loaded arrangement again locks into place, securing said shade body and said bottom rail at a desired height.

2. The shade apparatus, as recited in claim 1, further comprising a roller seat mounted on another end portion of said slide channel in said headrail and a hidden lift cord assembly, wherein said springs-loaded arrangement further comprises a roller unit mounted to one end of said slide seat facing said roller seat and said shade apparatus, wherein said hidden lift cord assembly has one or more internal lift cords that run vertically through said shade body and attached to said bottom rail and threaded horizontally through said roller unit and said roller seat inside said headrail, such that when said bottom rail is pushed upwards, said one or more lift cords move upward causing said shade body to gather and move toward said headrail, wherein as said one or more pairs of said coil springs tighten, said one or more internal lift cords are pulled and in turn to pull said shade said and said bottom rail upward, wherein when said bottom rail stops being pushed up, said springs-load arrangement automatically locks, holding said one or more internal lift cords in a new, raised position thereof, and that when said bottom rail is pulled down, said shade body is lowered and spread out evenly as said bottom rail moves downward to release tensions in said one or more pairs of said coil springs, wherein said one or more pairs of said coil springs allow said one or more internal lift cords to extend, lowering said shade body and said bottom rail, while ensuring a release of tension of each of said one or more pair of said coil springs is gradually, allowing for a smooth and light lowering of said shade body and said bottom rail, wherein when said bottom rail stops being pulled down, said springs-loaded arrangement again locks into place, securing said one or more internal lift cords and keep said shade body and said bottom rail at a desired height.

3. The shade apparatus, as recited in claim 1, wherein each of the two spring chamber seats has a receiving slot and one or more chamber walls dividing said receiving slot into two or more said spring chambers, such that said two spring chambers seats form said two or more pairs of said spring chambers, wherein each of said spring chambers has a curved top surface sized and shaped to match a curvature of each of said one or more pair of said coil springs so as to fittingly support said corresponding coil spring situated therein.

4. The shade apparatus, as recited in claim 2, wherein each of the two spring chamber seats has a receiving slot and one or more chamber walls dividing said receiving slot into two or more said spring chambers, such that said two spring chambers seats form said two or more pairs of said spring chambers, wherein each of said spring chambers has a curved top surface sized and shaped to match a curvature of each of said one or more pair of said coil springs so as to fittingly support said corresponding coil spring situated therein.

5. The shade apparatus, as recited in claim 1, wherein each of said one or more spring chambers is defined by two chamber side walls and a chamber top wall to define said bottom opening, such that each of said one or more pairs of said coil springs is fittingly situated between said two chamber side walls while said bottom opening allows said extension end of said coil spring to extend along an extension gap formed between a bottom of said slide seat and said bottom wall of said headrail and to securely connect to said spring base.

6. The shade apparatus, as recited in claim 2, wherein each of said one or more spring chambers is defined by two chamber side walls and a chamber top wall to define said bottom opening, such that each of said one or more pairs of said coil springs is fittingly situated between said two chamber side walls while said bottom opening allows said extension end of said coil spring to extend along an extension gap formed between a bottom of said slide seat and said bottom wall of said headrail and to securely connect to said spring base.

7. The shade apparatus, as recited in claim 3, wherein each of said one or more spring chambers is defined by two chamber side walls and a chamber top wall to define said bottom opening, such that each of said one or more pairs of said coil springs is fittingly situated between said two chamber side walls while said bottom opening allows said extension end of said coil spring to extend along an extension gap formed between a bottom of said slide seat and said bottom wall of said headrail and to securely connect to said spring base.

8. The shade apparatus, as recited in claim 4, wherein each of said one or more spring chambers is defined by two chamber side walls and a chamber top wall to define said bottom opening, such that each of said one or more pairs of said coil springs is fittingly situated between said two chamber side walls while said bottom opening allows said extension end of said coil spring to extend along an extension gap formed between a bottom of said slide seat and said bottom wall of said headrail and to securely connect to said spring base.

9. The shade apparatus, as recited in claim 1, wherein each of the sliding guider set includes two sliding guiders each has a guiding slot configured to allow one of said guiding rails to slidably insert therealong.

10. The shade apparatus, as recited in claim 8, wherein each of the sliding guider set includes two sliding guiders each has a guiding slot configured to allow one of said guiding rails to slidably insert therealong.

11. An adjusting method of a shade apparatus, comprising steps of:
providing a slide seat slidably in a slide channel of a headrail of said shade apparatus, wherein said slide seat having two or more pairs of spring chambers, wherein each of said two or more pairs of said spring chambers has a bottom opening which is closed by a bottom wall of said headrail when said slide seat is slidably disposed in said slide channel of said headrail with said bottom openings facing downwards; and
situating a first pair of coil spring in one pair of said two or more pairs of said spring chambers and connecting extension ends of said first pair of said coil springs to a spring base mounted on one end portion of said slide channel of said headrail.

12. The adjusting method, as recited in claim 1, wherein, in the situating step, said first pair of said coil springs is situated in a first pair of said two or more pairs of said spring chambers which is closest to said spring base.

13. The adjusting method, as recited in claim 12, further comprising steps of:
situating a second pair of coil springs to another pair of said two or more pairs of said spring chambers of said slide seat; and
connecting extension ends of said second pair of said coil springs to said spring base.

14. The adjusting method, as recited in claim 13, wherein said second pair of said coil springs is situated in a second pair of said two or more pairs of said spring chambers adjacent to said first pair of said spring chambers.

15. The adjusting method, as recited in claim 14, further comprising steps of:
situating a third pair of coil springs to a third pair of said two or more pairs of said spring chambers of said slide seat; and
connecting extension ends of said third pair of said coil springs to said spring base.

16. The adjusting method, as recited in claim 15, further comprising steps of:
situating a fourth pair of coil springs to a fourth pair of said two or more pairs of said spring chambers of said slide seat; and
connecting extension ends of said fourth pair of said coil springs to said spring base.

17. An adjusting method of a shade apparatus, comprising steps of:
providing a slide seat slidably in a slide channel of a headrail of said shade apparatus, wherein said slide seat comprising two or more pairs of spring chambers, wherein each of said two or more pairs of said spring chambers has a bottom opening which is closed by a bottom wall of said headrail when said slide seat is slidably disposed in said slide channel of said headrail with said bottom openings facing downwards, wherein said two or more pairs of said spring chambers have different distances to a spring base mounted on one end portion of said slide channel of said headrail; and
selectively situating a pair of coil springs in one of said two or more pairs of said spring chambers and connecting extension ends of said pair of the coil springs to said spring base to adjust tensions of said pair of said coil springs for balancing a weight of a shade body and a bottom rail of said shade apparatus.
